(19) United States
(12) Patent Application Publication
(10) Pub. No.: US 2005/0240406 A1
(43) Pub. Date: Oct. 27, 2005

(54) Speech recognition computing device display with highlighted text

(76) Inventor: David Carroll, Green Valley, AZ (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/111,398

(22) Filed: Apr. 21, 2005

Related U.S. Application Data
(60) Provisional application No. 60/564,632, filed on Apr. 21, 2004.

(51) Int. Cl. G10L 15/26

(52) U.S. Cl. 704/235

(57) ABSTRACT

A computing device having a display screen and a speech recognition module, and related method of operation. Received audio input is processed with the speech recognition module to convert the received audio input to text. At least a portion of the converted audio input is displayed as text on the display screen, including a first segment having a first format and a second segment having a second format. The first segment text is indicative of more recently received audio input as compared to the second segment. The first format is visually different from the second format. With this method, the user can readily distinguish the most recently spoken words when viewing the display screen.

### CROSS-REFERENCE TO RELATED APPLICATIONS

The subject matter of this patent application is related to the subject matter of U.S. Provisional Patent Application Ser. No. 60/564,632, filed Apr. 21, 2004 and entitled “Mobile Computing Devices” (Attorney Docket No. P374.104.101), priority to which is claimed under 35 U.S.C. §119(e) and an entirety of which is incorporated herein by reference.

### BACKGROUND

The present invention relates to operation of a computing device including a speech recognition module. More particularly, it relates to a method and device for displaying speech-converted text in a user-friendly manner.

The performance capabilities of speech recognition software have increased dramatically over recent years. Users of available speech recognition software have come to expect consistent conversion of spoken words into electronically stored and displayed text. Similar enhancements in microprocessor chips and related power supplies have raised the further possibility that speech recognition software can be employed with a hand-held, mobile personal computing device. Regardless of the end use, however, it has been discovered that the conventional manner in which the speech-converted text is displayed is less than optimal. In general terms, as the user dictates words, the converted or translated text is continuously displayed on the computing device's display screen. Where the display screen is relatively large (i.e., such as that associated with a standard desktop or laptop personal computer), this technique may be appropriate. However, where the displayed, speech-converted text is relatively small, such as when the displayed text is provided as a subset of a larger document and/or with a mobile, hand-held computing device that inherently has a small display screen, it has been discovered that users cannot easily identify the most recently uttered words. This inability, in turn, leads to user confusion when visually reviewing the converted, display text, such that the user may lose his or her train of thought and thus waste time. This is especially problematic where the user desires to visually confirm that translated words represent the actual words intended

Therefore, a need exists for a method of operating a computing device having a speech recognition module to enhance user identification of more recently spoken words, as well as a related computing device adapted to do the same.

### SUMMARY

One aspect of the present invention relates to a method of operating a computing device having a display screen and a speech recognition module. The method includes receiving audio input from a user over time. The received audio input is processed with the speech recognition module to convert the received audio input to text. At least a portion of the converted audio input is displayed as text on the display screen. In this regard, the displayed text includes a first segment having a first format and a second segment having a second format. The first segment text is indicative of more recently received audio input as compared to the second segment. With this in mind, the first format is visually different from the second format. With this method, then, the user can readily distinguish the most recently spoken/converted words when viewing the display screen. In one embodiment, the content of the first and second segments continuously change as additional audio input is received, such that a continuously scrolling text is displayed.

Another aspect of the present invention relates to a computing device for displaying content to a user. The computing device includes a housing, a display screen, a microphone, a speech recognition module, and a microprocessor. The speech recognition module is maintained by the housing and is electronically connected to the microphone for converting audio input received at the microphone to text. Finally, the microprocessor is electronically connected to the display screen and the speech recognition module. In this regard, the microprocessor is adapted to parse at least a portion of the converted text into a first segment and a second segment, the first segment being indicative of more recently received audio input as compared to the second segment. The processor is further adapted to assign a first format to the first segment and a second format to the second segment, as well as prompt the display screen to display the first segment text in the first format and the second segment text in the second format. With this in mind, the first format is visually different from the second format. In one embodiment, the computing device is a hand-held, mobile computing device.

### BRIEF DESCRIPTION OF THE DRAWINGS

FIG. 1 is a block diagram of a computing device in accordance with the present invention;

FIG. 2 is a perspective view of a display screen associated with the computing device of FIG. 1, displaying speech-converted text in accordance with one embodiment of a method in accordance with the present invention; and

FIG. 3 is a perspective view of the display screen of FIG. 2 after additional audio input has been received and processed.

### DETAILED DESCRIPTION

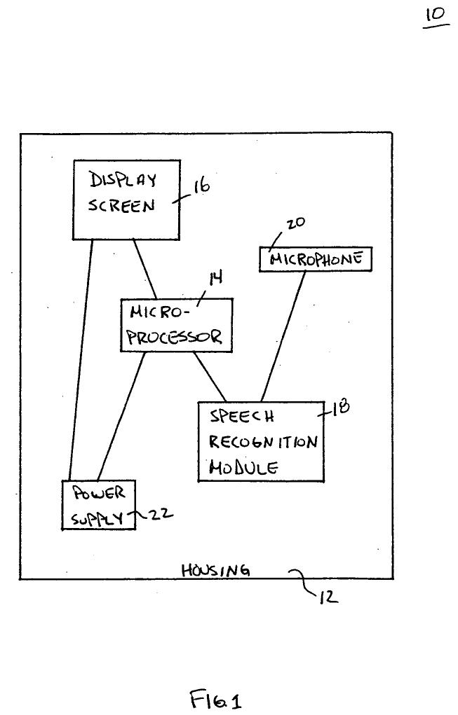

One embodiment of a computing device 10 in accordance with the present invention is shown in the block diagram of FIG. 1. The computing device 10 includes a housing 12, a microprocessor 14, a display screen 16, a speech recognition module 18, a microphone 20, and a power source 22. In addition, the computing device may include one or more auxiliary components (not shown) such as other operational modules (e.g., word processing, internet browser, etc.), speaker(s), wireless connections, etc. In one embodiment, the computing device 10 is a hand-held, mobile computing device such that the housing 12 maintains the remaining components 14-22. Alternatively, the computing device 10 can be akin to a desktop personal computer such that one or more of the display screens 16, the microphone 20, and/or the power source 22 are maintained external to the housing 12. Regardless, and in general terms, the microprocessor 14 is electronically connected to the display screen 16 and the speech recognition module 18. The speech recognition module 18 receives audio input from the microphone 20, converting spoken words by a user (not shown) into text. The microprocessor 20, in turn, prompts the display screen 16 to display the speech-converted text in the manner described below.

In general terms, the computing device 10 can assume a wide variety of forms that otherwise incorporate a number of different operational features. For example, the computing device 10 can be a mobile phone, a hand-held camera, a portable computing device, a desktop or laptop computing device, etc. All necessary components and software for performing the desired operations associated with the designated end use is not necessarily shown in FIG. 1, but is/are readily incorporated therein (e.g., input/output ports, wireless communication modules, etc.). With this in mind, the housing 12 can assume a variety of forms appropriate for the end use. For example, in one embodiment in which the computing device 10 is a hand-held, mobile computing device, the housing 12 is sized to be held by the hand(s) of the user (not shown), maintaining not only the microprocessor 14 and the speech recognition module 18, but also the display screen 16, the power source 22, and possibly the microphone 20. Alternatively, one or more of the display screen(s) 16, the microphone 20, and/or the power source 22 can be connected to appropriate components of the computing device 10 via one or more ports formed in the housing.

The microprocessor 14 can assume a variety of forms known in the art or in the future created, including, for example, Intel® Centrino™ and chips and chip sets (e.g., Efficeon™) from Transmeta Corp., of Santa Clara, Calif. In most basic form, however, the microprocessor 14 is capable of receiving information from the speech recognition module 18 in the form of converted text, and prompting the display screen 16 to display text in the manner described below. While the speech recognition module 18 (described below) has been shown apart from the microprocessor 14, in an alternative embodiment, the speech recognition module 18 is provided as part of the microprocessor 14 (e.g., stored in a memory component associated with the microprocessor 14).

The display screen 16 is of a type known in the art or in the future created. With the one embodiment in which the computing device 10 is a hand-held mobile computing device, the display screen 16 is of a relatively small physical size, for example on the order of 2 inches×2 inches, and can incorporate a wide variety of technologies (e.g., pixel size, etc.). In an alternative embodiment, the display screen 16 is provided apart from the housing 12, and is a conventional desktop or laptop display screen.

The speech recognition module 18 can be any module (including appropriate hardware and software) capable of processing sounds received at the microphone 20 (or additional microphones (not shown)). Programming necessary for performing speech recognition operations can be provided as part of the speech recognition module 18, as part of the microprocessor 14, or both. Further, the speech recognition module 18 can be adapted to perform various speech recognition operations, such as speech translation either by software maintained by the module 18 or via a separate sub-system module (not shown). Exemplary speech recognition modules include, for example, Dragon NaturallySpeaking® from ScanSoft, Inc., of Peabody, Mass., or MicroSoft® Speech Recognition Systems (beta).

In one embodiment, the microphone 20 is a noise-cancelling microphone as known in the art, although other designs are also acceptable. While the microphone 20 is illustrated in FIG. 1 as being maintained by the housing 12, in alternative embodiments, the microphone 20 is provided apart from the housing 12, electronically connected to the speech recognition module 18 via an appropriate connector (i.e., wire or wireless). In alternative embodiments, two or more of the microphones 20 are provided.

The power source 22 is, in one embodiment, appropriate for operating the computing device 10 as a hand-held mobile computing device. Thus, for example, the power source 22 is, in one embodiment, a lithium-based, rechargeable battery such as a lithium battery, a lithium ion polymer battery, a lithium sulfur battery, etc. Alternatively, a number of other battery configurations are equally acceptable for use as the power source 22. Alternatively, where the computing device 10 is akin to a desktop computing device, the power source 22 can be an electrical connection to an external power source.

Regardless of the exact configuration of the computing device 10, a user (not shown) can operate the computing device 10 to perform a speech recognition and text conversion/display operation. For example, the user provides audio input (e.g., spoken words) at the microphone 20. The speech recognition module 18 receives the audio input and converts or translates the audio input into text (i.e., converts a spoken word into a text word). The microprocessor 14, in turn, receives the converted text and prompts the display screen 16 to display the converted text. To this end, the microprocessor 14 is adapted to parse the speech-converted text into at least a first segment and a second segment on a continuous basis. In this regard, the first segment text is representative of more recently received/converted speech generated by the speech recognition module 18 as compared to the second segment. By way of example, a user may say the phrase “this is normal font as input by speech recognition and this is the easier to read font for the most recent words.” The microprocessor 14 can parse this statement into a first segment consisting of “this is the easier to read font for the most recent words” and a second segment consisting of “This is normal font as input by speech recognition and”. The parameters for defining a “length” of a particular segment is described in greater detail below. Regardless, the microprocessor 14 is capable of continuously changing the content of the first and second segments (as well as additional segments where desired) as additional audio input is received, as well as assign a first format to the first segment and a second format to the second segment, with these first and second segments being displayed in the so-assigned format on the display screen 16.

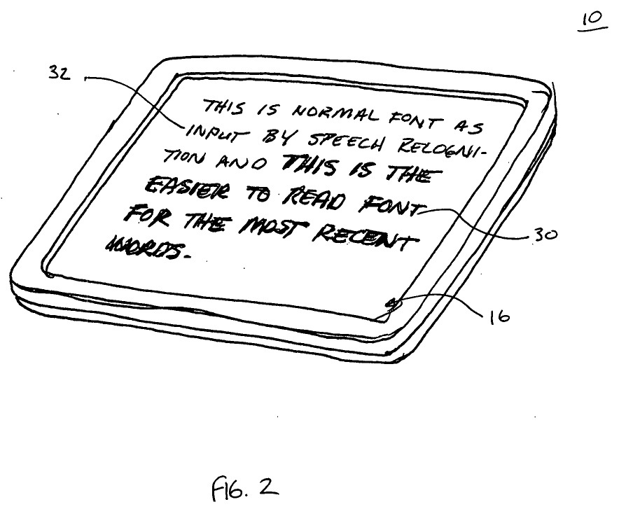

By way of continuing example, the first and second segments described above can be displayed in the first and second formats as shown in FIG. 2. In particular, the first segment (and thus the first format) is generally designated at 30, whereas the second segment (and thus the second format) is indicated generally at 32. As illustrated in FIG. 2, the first format 30 is visually different from the second format 32. For example, in one embodiment, the first format 30 is a larger font as compared to the second format 32. Alternatively, or in addition, the first format 30 can be a different type font as compared to the second format 32. Alternatively, or in addition, the first format 30 can be “bolded” as compared to the second format 32. Alternatively, or in addition, the first format 30 can be of a different color and/or highlighted as compared to the second format 32. A variety of other display techniques can be employed such that the first format 30 is visually different from the second format 32. In alternative embodiments, the computing device 10 is configured such that the user (not shown) can select a desired format characteristic(s) of at least the first format 30 (e.g., the user can dictate that the first format 30 includes all words shown with underline) via an appropriate input device (e.g., touch pad, keyboard, voice command, styles, etc.). Regardless, because the first segment text 30 is visually distinct from the second segment text 32, a user will more readily identify the most recently spoken words/phrases on the display screen 16. Thus, the user can easily assure correct conversion/translation of voice to word, review the on-going conversion/translation without losing their train of thought, etc.

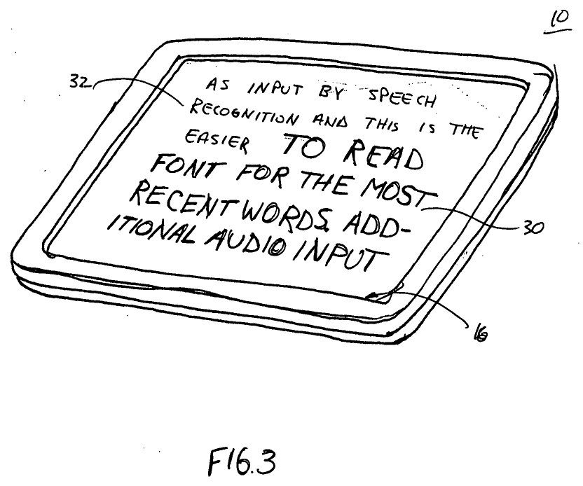

As indicated above, in one embodiment, the microprocessor 14 (FIG. 1) continuously updates the displayed first and second segments 30, 32 as additional audio input as received/converted. As such, the resultant display on the display screen 16 will continuously change, resulting in a scrolling display throughout the speech recognition process. For example, and as a continuation of the example described above, where the user (not shown) further speaks the words “Additional audio input”, the microprocessor 14 prompts the display screen 16 to alter the displayed content as shown in FIG. 3. As shown, the first segment 30 (incorporating the first format) now reads “to read font for the most recent words. Additional audio input.”, whereas the second segment (and thus, the second format) 32 reads “as input by speech recognition and this is the easier”.

The length of at least the first segment 30 (e.g., number of characters) is determined, assigned, and applied by the microprocessor 14 (FIG. 1). For example, in one embodiment, the microprocessor 14 is programmed to designate a set character length or number of words assigned to the first segment 30. Alternatively, or in addition, the microprocessor 14 can be adapted to adjust a length of the first segment 30 based on a designated time period. For example, the length of the first segment 30 can vary, encompassing all converted words/phrases received within the immediate preceding ten seconds. Of course, a smaller or larger time frame can be employed. Alternatively, or in addition, the user can designate or change the assigned length of the first segment 30 via an appropriate input device (not shown), such as a touch screen, keyboard, stylus, etc.

The above-described display technique is highly applicable to a computing device incorporating a relatively small display screen, such as a hand-held mobile computing device. Under these circumstances, the size of the display screen inherently limits the number of character/words that can be perceptively displayed, such that by highlighting the most recently received/converted words, they will be more readily identified by the user. However, the method and device of the present invention is equally applicable to systems incorporating a larger display screen. To this end, and with either approach, the displayed text (e.g., as shown in FIGS. 2 and 3) can be provided within a smaller window of the overall display area provided by the display screen 16. Under these circumstances, and in one embodiment, the computing device 10 of the present invention is further adapted to allow the user to alter the size, magnification, and/or location of the text-containing window via mouse, switch, speech input, sensor-based zoom/pan/tilt, etc.

The method and device of the present invention provides a marked improvement over previous speech recognition-based computing devices. By displaying the most recently-received/converted text in a format visually distinguishable from prior converted and displayed text, the user can more readily assure correct translation of voice to word, especially on small display screens associated with hand-held, mobile computing devices.

Although the present invention has been described with reference to preferred embodiments, workers skilled in the art will recognize that changes can be made in form and detail without departing from the spirit and scope of the present invention.

1. A method of operating a computing device having a display screen and a speech recognition module, the method comprising:
receiving audio input from a user over time;
processing the received audio input with the speech recognition module to convert the received audio input to text; and
displaying at least a portion of the converted audio input as text on the display screen, the displayed text including a first segment having a first format and a second segment having a second format, the first segment text being more recently received audio input as compared to the second segment;
wherein the first format is visually different from the second format.

2. The method of claim 1, wherein a font of the first format is larger than a font of the second format.

3. The method of claim 1, wherein the first format includes bolded text as compared to the second format.

4. The method of claim 1, wherein the first format incorporates a color different from a color of the second format.

5. The method of claim 1, wherein content of the first and second segments continuously changes as additional audio input is received and converted.

6. The method of claim 5, further comprising:
operating the computing device to continuously transfer a later received portion of the first segment text to the second segment.

7. The method of claim 6, further comprising:
designating a length of the first segment.

8. The method of claim 7, wherein the designated length is a function of time.

9. The method of claim 7, wherein the designated length is a function of number of characters.

10. The method of claim 7, further comprising:
receiving information from the user for determining the designated length.

11. The method of claim 7, further comprising:
changing the designated length of the first segment in response to a user input.

12. The method of claim 5, further comprising:
continuously scrolling the displayed text as additional audio input is received.

13. The method of claim 1, wherein the display text is displayed in a window defined on the display screen, the method further comprising:
changing a location of the window relative to a perimeter of the display screen in response to a user input.

14. The method of claim 1, wherein the computing device is a mobile, hand-held personal computing device including a microprocessor.

15. A computing device for displaying content to a user, the computing device comprising:
a housing;
a display screen;
a microphone;
a speech recognition module electronically connected to the microphone for converting audio input received at the microphone to text; and
a microprocessor electronically connected to the display screen and the speech recognition module, the microprocessor adapted to:
parse at least a portion of the converted text into a first segment and a second segment, the first segment being indicative of more recently received audio input as compared to the second segment,
assign a first format to the first segment and a second format to the second segment,
prompt the display screen to display the first segment text in the first format and the second segment text in the second format;
wherein the displayed first format is visually different from the displayed second format.

16. The computing device of claim 15, wherein a font of the displayed first format is larger than a font of the displayed second format.

17. The computing device of claim 15, wherein the processor is further adapted to continuously change content of the displayed first and second segments as additional audio input is received at the microphone.

18. The computing device of claim 15, wherein the microprocessor is further adapted to define a length of the first segment based upon a factor selected from the group consisting of number of characters and time.

19. The computing device of claim 15, wherein the computing device is a hand-held, mobile computing device such that the display screen is maintained by the housing.
